(19) United States
(12) Patent Application Publication
(10) Pub. No.: US 2006/0035790 A1
(43) Pub. Date: Feb. 16, 2006

(54) Control of particulate flowback in subterranean formations using elastomeric resin coated proppants

(75) Inventors: Patrick R. Okell, Bellaire, TX (US); A. Richard Sinclair, Houston, TX (US); Syed Akbar, Pearland, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: Fairmount Minerals, Ltd.

(21) Appl. No.: 11/200,482

(22) Filed: Aug. 9, 2005

Related U.S. Application Data
(60) Provisional application No. 60/601,811, filed on Aug. 16, 2004.

(51) Int. Cl. C09K 8/80; B32B 19/00; E21B 43/00

(52) U.S. Cl. 507/269; 428/407; 427/212

(57) ABSTRACT

Coated composite proppant particles made of particulate substrates having an elastomeric coating are provided for use in reducing particulate flowback in subterranean formations. The disclosed proppant particles can have a coating of resin, fibrous materials, and/or soluble resin coatings in addition to an elastomeric coating. Methods of making the coated particles are also described, as well as their use in subterranean formations.

### CROSS REFERENCE TO RELATED APPLICATION

This application claims priority to U.S. Provisional Patent Application Ser. No. 60/601,811, filed Aug. 16, 2004, entitled, “Control of Patriculate Flowback in Subterranean Formations Using Elastomeric Resin Coated Proppants,” by Patrick R. Okell, et al., which is herein incorporated in its entirety for all purposes.

### FIELD OF THE INVENTION

The invention relates to means for recovering hydrocarbons from a subterranean formation and, more particularly, to a method and means for controlling transport of fine particulate solids produced during a stimulation treatment during the subsequent production of hydrocarbons from a subterranean formation. In particular, a particulate having an elastomeric coating for use in controlling flowback during subterranean operations, processes for its preparation and methods for its use is disclosed.

### DESCRIPTION OF RELATED ART

Transport of particulate solids during the production of hydrocarbons from a subterranean formation is a continuing problem. The transported solids can erode or cause significant wear in the hydrocarbon production equipment used in the recovery process. The solids also can clog or plug the wellbore thereby limiting or completely stopping fluid production. Further, the transported particulates must be separated from the recovered hydrocarbons adding further expense to the processing.

The particulates which are available for transport may be present due to the nature of a subterranean formation and/or as a result of well stimulation treatments wherein proppant is introduced into a subterranean formation.

In the treatment of subterranean formations, it is common to place particulate materials as a filter medium and/or a proppant in the near wellbore area and in fractures extending outwardly from the wellbore. In fracturing operations, proppant is carried into fractures created when hydraulic pressure is applied to these subterranean rock formations to a point where fractures are developed. Proppant suspended in a viscosified fracturing fluid is carried outwardly away from the wellbore within the fractures as they are created and extended with continued pumping. Upon release of pumping pressure, the proppant materials remain in the fractures holding the separated rock faces in an open position forming a channel for flow of formation fluids back to the wellbore.

Introduction of the proppant materials into the fracturing fluid often results in the crushing of some portion of the proppant material as it passes through the pumping and mixing equipment to enter the subterranean formation. This fine crushed material may have a particle size ranging from slightly below the size of the original proppant material to less than 600 mesh on the U.S. Sieve Series. Also, when the formation closes at the conclusion of the treatment, some crushing of the proppant material may occur producing additional fines. Even when proppant crushing does not occur, however, the subterranean formation may itself release fines from the face of the created fractures as a result of spalling, scouring of the formation wall which causes formation particulate to be mixed with the proppant and the like. These fine formation materials also may range from formation grain size to less than 600 mesh. The fines may comprise sand, shale or hydrocarbons such as coal fines from coal degasification operations and the like. When the wellbore subsequently is produced (that is, hydrocarbon production is continued), the fines tend to move into the proppant pack in the fracture, tending to reduce the permeability of the pack. The fines also can flow with any hydrocarbons produced from the wellbore to the surface.

This undesirable result causes undue wear on production equipment and the need for separation of solids from the produced hydrocarbons. Fines flowback often may be aggravated by what is described as “aggressive” flowback of the well after a stimulation treatment, such as hydraulic fracturing. Aggressive flowback generally entails flowback of the treatment fluid at a rate of from about 0.001 to about 0.1 barrels per minute (BPM) per perforation of the treatment fluids which were introduced into the subterranean formation. Such flowback rates accelerate or force closure of the formation upon the proppant introduced into the formation. The rapid flowrate can also result in large quantities of fines flowing back into the near wellbore as closure occurs, causing permeability loss within the formation. The rapid flowback is highly desirable for the operator as it returns a wellbore to production of hydrocarbons significantly sooner than would result from other techniques.

Currently, the primary means for addressing the formation particulate or fines problem is to employ resin-coated proppants or resin consolidation of the proppant which is not capable of use in aggressive flowback situations. Resin-coated proppant is not always effective at forming a filtration bed since there is some difficulty in placing it uniformly within the fractures and, additionally, the resin coating could effect fracture conductivity. Resin coated proppant also may interact chemically with common fracturing fluid crosslinking systems such as guar or hydroxypropylguar with organo-metallics or borate crosslinkers (chemicals in the resin interact). This interaction results in altered crosslinking and/or break times for the fluids thereby affecting production.

In unconsolidated formations, it is common to place a filtration bed of gravel in the near-wellbore area in order to present a physical barrier to the transport of unconsolidated formation fines with the production of hydrocarbons. Typically, such so-called “gravel packing operations” involve the pumping and placement of a quantity of gravel and/or sand having a mesh size between about 10 and 60 mesh on the U.S. Standard Sieve Series into the unconsolidated formation adjacent to the wellbore. Sometimes multiple particle size ranges are employed within the gravel pack. It is sometimes also desirable to bind the gravel particles together in order to form a porous matrix through which formation fluids can pass while straining out and retaining the bulk of the unconsolidated sand and/or fines transported to the near wellbore area by the formation fluids. The gravel particles may constitute a resin-coated gravel which is either curable or pre-cured. Some resins can be cured by an overflush of a chemical binding agent once the gravel is in place. It has also been known to add various hardenable binding agents or hardenable adhesives directly to an overflush of unconsolidated gravel in order to bind the particles together, such as those described in U.S. Pat. No. 5,492,178.

Numerous other attempts to successfully address the flowback problem have been garnered in the patent literature. U.S. Pat. Nos. 5,330,005, 5,439,055, 5,501,275 and 6,172,011 to Card, et al., suggest methods for overcoming the difficulties of resin coating proppants or gravel packs by the incorporation of a fibrous material in the fluid with which the particulates are introduced into the subterranean formation. The fibers generally have a length ranging upwardly from about 2 millimeters and a diameter of from about 6 to about 200 microns. Fibrillated fibers of smaller diameter may also be used. According to the details of these patents, the fibers are believed to act to bridge across constrictions and orifices in the proppant pack and form a mat or framework which holds the particulates in place, thereby limiting particulate flowback. The fibers typically result in a 25 percent or greater loss in permeability of the proppant pack that is created in comparison to a pack without the fibers.

While this technique may function to limit some flowback, it fails to secure the particulates to one another in the manner achieved by use of resin coated particulates.

U.S. Pat. No. 5,551,514 discloses a method for sand control that combines resin consolidation and placement of a fibrous material in intimate mixture with the particulates to enhance production without a gravel pack screen.

In U.S. Pat. No. 5,604,184 (issued Feb. 18, 1997) to Ellis, et al., a method for propping a fracture using chemically inert resin-coated proppant for controlling flowback is offered. The proppant is described as being coated with a resin fluid containing a polymerizable oligomer of furfuryl alcohol resin, a catalyst such as a slightly water soluble organic acid (e.g., o-nitrobenzoic acid), and an ester of a weak organic acid (e.g., alkyl alkanoates) to consume any water produced by the polymerization of the resin. Upon placement of the coated proppant downhole, the combination of the action of the heat of the subterranean formation and the catalyst initiate the polymerization catalyst, allowing the alcohol oligomer to polymerize and form a resin mass that retains sufficient permeability to allow fluid flow.

A method of treating a wellbore to reduce fine particulate flowback is suggested in U.S. Pat. No. 5,871,049 (issued Feb. 16, 1999) to Weaver, et al. The method described includes the steps of providing a fluid suspension that includes a mixture of particulate material coated with a tackifying compound and pumping the fluid suspension into a subterranean formation. The tackifying compound reportedly provides a retardation of movement of a portion of particulate within the formation. As an alternative embodiment, the tackifying compound can be introduced into the formation in a diluent solution separate from the particulate material, thereby depositing on the previously introduced particulates and hindering their movement during hydrocarbon recovery operations.

In U.S. Pat. No. 6,114,410 to Betzold, et al. (issued Sep. 5, 2000), proppants containing both bondable particles and “removable” particles, as well as methods for their use, are offered as suitable for increasing fracture conductivity and reducing proppant flowback. According to the details of the patent, the proppant contains a mixture of bondable particles and removable particles. The bondable particles the consist of particles coated with a curable resin and being capable of adhering to one another within the subterranean formation to form a substantially permanent, self-supporting matrix interspersed with removable particles, while the removable particles are capable of being substantially removed from the matrix by a fluid processed in the subterranean formation after the bondable particles form the matrix. According further to this patent, once the mixture of bondable and removable particles is placed within a subterranean formation, the bondable particles adhere to adjacent bondable particles to form a permanent matrix. In using such a proppant, the conductivity of the fracture and the overall productivity of the hydraulic operation is increased, while particulate flowback is decreased.

U.S. Pat. No. 6,209,643 to Nguyen, et al (issued Apr. 3, 2001) suggests a method of controlling particulate flowback in a subterranean wells by introducing a treatment fluid having controlled release treatment chemicals. According to the method, a fluid suspension that include a mixture of a particulate, a tackifying compound that contains a polyamide containing predominately a condensation reaction product of a dimer acid containing some trimer and higher oligomers and some monomer acids with a polyamine, and a treatment chemical are pumped into the subterranean formation. The tackifying compound reportedly serves to retard movement of at least a portion of the particulate within the formation upon flow of fluids back out of the formation.

Not all of the approaches to solving the flowback problem are based on modifying the proppant or the fracturing fluid. U.S. Pat. No. 6,659,179 (issued Dec. 9, 2003) describes a method of controlling proppant flowback in a subterranean well. According to the specification, a treating mixture containing proppant is pumped from the wellbore casing through the perforated section of the cased wellbore, and out into the formation. Following injection in the fracture, a screen is circumferentially expanded in the casing and hydrocarbons are allowed to flow back through the perforations and up the wellbore. The screen reportedly prevents the particulate materials from flowing back into the well. However, this method suffers from the difficulties associated with placing the screen down the wellbore and adequately blocking proppant flowback.

Published U.S. patent application No. 2003/0186820 A1 to Thesing describes a method of treating a subterranean formation with a particulate having an elastomer-forming component in order to effect flowback control. As described therein, the silicone-based elastomer-forming component and the particulate are mixed together prior to mixing with a fluid for carrying the particulate into the subterranean formation. The entire particle/silicone rubber elastomer-forming component/fluid mixture is then deposited in the formation, whereupon reaching formation temperatures and pressures (e.g., 300 F), the silicone rubber softens due to its high thermal stability and partially encapsulates the particulate material, “forming a flexible or resilient coating on the particulate” in the formation. According specifically to the application, the elastomer-forming component is capable of being cured to form an elastomeric material, and is capable of forming the particulate into a flexible and coherent mass. Further, “the elastomer-forming component forms a silicone rubber upon curing” (para. 0041), and is exemplified as being an un-cured silicone rubber component such as “Wacker Elastosil® E-70” which is dry coated onto the particulate. Wacker E-70 is a one-component silicone rubber having a density of 1.22 g/cm³ and a tensile strength of 3.5 N/mm². This approach, however, suffers from having to attempt to control the coating and encapsulation process downhole, and the price of using silicone rubber as a coating compound for particulate material.

Effective proppant flowback control methods have also been proposed wherein the shape of the proppant is modified (e.g., SPE 77681; SPE 56593), using a variety of chemical additives such as thermoplastic film materials (SPE 36689; Nguyen, P. D., et al., 1996), as well as numerous other approaches. See, for example, SPE 84312 (Stephenson, C. J., et al., 2003) describing effective flowback control approaches following hydraulic fracturing treatments; SPE 77745 (Anderson, R. W., et al., 2002) describing some of the new resin technology available for use in flowback control; SPE 82215 (Nguyen, P. D., et al., 2003) suggesting methods of controlling proppant flowback with resin-coated proppants; SPE 68202 (Terracina, J., et al., 2001) describing the use of proppant surface-modification agents to reduce proppant flowback in high-rate wells; and SPE 56726 (Parker, M., et al., 1999), which describes the general state of the art in the area of flowback control and analyses flowback using computer modeling systems.

Thus, it would be desirable to provide a method which will bind greater numbers of fines particles to the proppant material in such a manner that it further assists in preventing movement or flowback of particulates from a wellbore or formation without significantly reducing the permeability of the particulate pack during aggressive flowback of treatment fluids.

### SUMMARY OF THE INVENTION

The present invention provides proppants and methods of using such proppants for treating a subterranean formation, and a resultant porous proppant pack that inhibits the flow of fine particulates back into and through the wellbore during hydrocarbon production following a fracturing operation, without substantially inhibiting the permeability of the proppant pack.

In one embodiment of the present invention, a proppant particle for use in reducing flowback is described, wherein the proppant particle has an elastomer coating.

In another embodiment of the present invention, a proppant particle for use in reducing flowback in subterranean formations is described, wherein the proppant particle has a pre-cured or curable resin coating and an elastomer coating.

In a further embodiment of the present invention, a proppant particle for use in reducing flowback in subterranean formations is described, wherein the proppant particle has a coating that is a mixture of a resin coating and an elastomer is described.

In another embodiment of the present invention, a proppant particle for use in reducing flowback in subterranean formations is described, wherein the proppant particle has a pre-cured or curable resin coating, an elastomer coating, and soluble or insoluble fibers included in one or both of the coatings.

In yet another embodiment of the present invention, a proppant particle for use in reducing flowback in subterranean formations is described, wherein the proppant particle has a pre-cured or curable resin coating, an elastomer coating, and a soluble resin outer coating.

In another embodiment of the present invention, processes for preparing proppant particles having an elastomer coating are described.

In yet another embodiment of the present invention, methods of treating a hydraulically induced fracture in a subterranean formation to prevent particles from the subterranean formation from flowing back into the wellbore are described, wherein the method comprises introducing into the proppant pack coated proppant particles having an elastomer in the coating.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1 shows one embodiment of the present disclosure, wherein a particulate is coated with an elastomer.

FIG. 2 shows a further embodiment of the present disclosure, wherein a particulate is coated with both a phenolic resin coating and an elastomeric coating.

FIG. 3 illustrates another embodiment of the present disclosure, wherein a particulate is coated with a phenolic resin coating, an elastomeric coating, and wherein fibers are incorporated into the elastomers coating.

FIG. 4 illustrates a further embodiment of the present disclosure, wherein a particulate is coated with a phenolic resin coating, an elastomeric coating, and a soluble resin coating.

FIG. 5 illustrates another embodiment of the present disclosure, wherein a particulate is coated with a mixture of phenolic resin and an elastomer.

FIG. 6 shows the unconfined compressive strength of an elastomer-coated proppant of Example 2 (described herein) crushed and tested six times in order to determine its compressive strength.

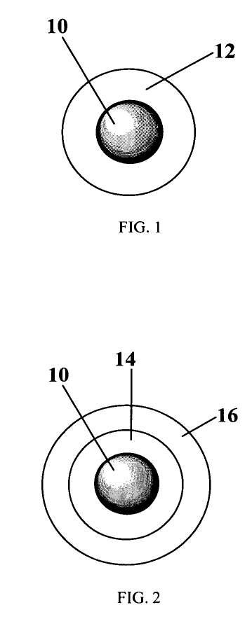

### DEFINITIONS

The following definitions are provided in order to aid those skilled in the art in understanding the detailed description of the present invention.

The term “elastomer”, or “elastomeric”, as used herein, refers to compositions or materials that have a glass transition temperature, T_{g}, at which there is an increase in the thermal expansion coefficient, and includes both amorphous polymer elastomers and thermoplastics. Specifically preferred for use herein are elastomers which have low T_{g}'s, e.g., below 600° F., densities (or specific gravities) less than about 1.0 g/cm³, and tensile strengths greater than about 10 Pa, and preferably greater than about 1 kPa This includes polyolefin elastomers, polyurea elastomers, polyurethane elastomers, latexes, and thermoplastic compounds/elastomers. As used herein, the term “elastomer” or “elastomeric compound” does not include silicone- or silica-based elastomers, or silicone-containing elastomers or rubbers.

In embodiments described and disclosed herein, the use of the term “introducing” includes pumping, injecting, pouring, releasing, displacing, spotting, circulating, or otherwise placing a fluid or material within a well, wellbore, or subterranean formation using any suitable manner known in the art. Similarly, as used herein, the terms “combining”, “contacting”, and “applying” include any known suitable methods for admixing, exposing, or otherwise causing two or more materials, compounds, or components to come together in a manner sufficient to cause at least partial reaction or other interaction to occur between the materials, compounds, or components.

The term “proppant”, as used herein, refers to those sized particles that are used in well work-overs and treatments, such as hydraulic fracturing operations, to hold fractures open following the treatment. Such sized particles are often mixed with fracturing fluid(s) to hold fractures open after a hydraulic fracturing treatment or similar downhole well treatment. In addition to naturally occurring sand grains, the term “proppant” includes man-made or specially engineered proppants, such as resin-coated sand or high-strength ceramic materials like sintered bauxite. Typically, but not necessarily, proppant materials are carefully sorted for size and sphericity to provide an efficient conduit for production of fluid from the reservoir to the wellbore.

### DETAILED DESCRIPTION OF THE INVENTION

The present invention provides particle compositions comprising elastomer material coatings, as well as processes for preparing such compositions. These compositions are useful in subterranean formations for reducing or minimizing the amount of proppant particulate flowback during a hydraulic fracturing operation.

While compositions and methods are described in terms of “comprising” various components or steps, the compositions and methods can also “consist essentially of” or “consist of” the various components and steps.

A. Substrate

Particulate material, also referred to herein as substrate material, suitable for use with the present invention includes a variety of particulate materials known to be suitable or potentially suitable propping agents which can be employed in downhole operations. In accordance with the present invention, the particulate material (or substrate material) which can be used include any propping agent suitable for hydraulic fracturing known in the art. Examples of such particulate materials include, but are not limited to, natural materials, silica proppants, ceramic proppants, metallic proppants, synthetic organic proppants, mixtures thereof, and the like.

Natural products suitable for use as proppants include, but are not limited to, nut shells such as walnut, brazil nut, and macadamia nut, as well as fruit pits such as peach pits, apricot pits, olive pits, and any resin impregnated or resin coated version of these. Typical resin coatings or impregnations include bisphenols, bisphenol homopolymers, blends of bisphenol homopolymers with phenol-aldehyde polymer, bisphenol-aldehyde resins and/or polymers, phenol-aldehyde polymers and homopolymers, modified and unmodified resoles, phenolic materials including arylphenols, alkylphenols, alkoxyphenols, and aryloxyphenols, resorcinol resins, epoxy resins, novolak polymer resins, novolak bisphenol-aldehyde polymers, and waxes, as well as the precured or curable versions of such resin coatings.

Silica proppants suitable for use with the present invention include, but are not limited to, glass spheres and glass microspheres, glass beads, silica quartz sand, sintered Bauxite, and sands of all types such as white or brown. Typical silica sands suitable for use include Northern White Sands (Fairmount Minerals, Chardon, Ohio), Ottawa, Jordan, Brady, Hickory, Arizona, St. Peter, Wonowoc, and Chalfort, as well as any resin coated version of these sands. In the case of silica fibers being used, the fibers can be straight, curved, crimped, or spiral shaped, and can be of any grade, such as E-grade, S-grade, and AR-grade. Examples of suitable resin-coated silica proppants for use with the present invention include deformable proppants such as FLEXSAND LS™ and FLEXSAND MS™ (available from BJ Services, Inc., Houston, Tex.) and Tempered HS®, Tempered LC®, Tempered DC®, and Tempered TF® tempered proppants, all available from Santrol, Fresno, Tex.

Ceramic proppants suitable for use with the methods of the present invention include, but are not limited to, ceramic beads; spent fluid-cracking catalysts (FCC) such as those described in U.S. Pat. No. 6,372,378, which is incorporated herein in its entirety; ultra lightweight porous ceramics; economy lightweight ceramics such as “ECONOPROP™” (Carbo Ceramics, Inc., Irving, Tex.); lightweight ceramics such as “CARBOLITE™”; intermediate strength ceramics such as “CARBOPROP™” (available from Carbo Ceramics, Inc., Irving, Tex.); high strength ceramics such as “CARBOHSP™” and “Sintered Bauxite” (Carbo Ceramics, Inc., Irving, Tex.), and HYPERPROP G2™, DYNAPROP G2™, or OPTIPROP G2™ encapsulated, curable ceramic proppants (available from Santrol, Fresno, Tex.) as well as any resin coated or resin impregnated versions of these, such as described above.

Metallic proppants suitable for use with the embodiments of the present invention include, but are not limited to, aluminum shot, aluminum pellets, aluminum needles, aluminum wire, iron shot, steel shot, and the like, as well as any resin coated versions of these metallic proppants.

Synthetic proppants are also suitable for use with the present invention. Examples of suitable synthetic proppants include, but are not limited to, plastic particles or beads, nylon beads, nylon pellets, SDVB (styrene divinyl benzene) beads, carbon fibers such as PANEX™ carbon fibers from Zoltek Corporation (Van Nuys, Calif.), and resin agglomerate particles similar to “FLEXSAND MS™” (BJ Services Company, Houston, Tex.), as well as resin coated versions thereof.

Additionally, soluble materials suitable for use as proppants are also envisioned to be useful with the methods of the present invention. For example, soluble proppants which are placed in the channels of the created perforations include, but are not limited to, marble or limestone chips or any other suitable carbonate particulates. Additionally, wax, plastic, or resin particles, either coated or uncoated, which are either soluble through contact with a treatment chemical or can melt and flowback from the fracture are suitable for use as proppants with the present invention.

Suitable with the present invention, propping agents are typically used in concentrations from about I to about 18 pounds per gallon (about 120 g/L to about 2,160 g/L) of fracturing fluid composition, but higher or lower concentrations may also be used as required.

Similarly, the particulate substrate suitable for use with the present invention has a particle size in the range of USA Standard Testing screen numbers from about 4 to about 200 (i.e., screen openings of about 0.18 inch to about 0.003 inch). More particularly, particulate substrate sizes suitable for use with the present invention include size ranges from about 4 mesh (4750 microns) to about 200 mesh (75 microns). Also suitable for use with the present invention are particulate materials or proppants having size designations of 6/12, 8/16, 12/18, 12/20, 16/20, 16/30, 20/40, 30/50, 40/70 and 70/140, although any desired size distribution can be used, such as 10/40, 14/20, 14/30, 14/40, 18/40, and the like, as well as any combination thereof (e.g., a mixture of 10/40 and 14/40). The preferred mesh size, in accordance with the present invention, is 20/40 mesh.

Elastomers

Elastomers suitable for use with the present invention are polymeric elastomers which do not contain silicone, have a density (or specific gravity) less than about 1.0, and/or have specific characteristics making them ideal for their use herein, including but not limited to glass transition temperature (T_{g}), tensile strength, and elongation at break. Polymers suitable for use with the present invention as elastomers include but are not limited to polyolefin elastomers, such as copolymers of ethylene, butane, and 1 or 2 octene; copolymers of ethylene and trans 2-butene; syndiotactic polyethylene; isotactic polyethylene; water borne acrylics; latexes; and thermoplastic compounds, including thermoplastic polyoctene compounded with talc or titanium dioxide, thermoplastic elastomers compounded with thermoplastic polymers, thermoplastic polyurethane elastomers and thermoplastic elastomers compounded with thermoset polymers.

Preferably, the elastomers used within the present invention are thermoplastic polyurethane elastomers having a low melt viscosity, low density, and a low glass-transition temperature. Such elastomers include but are not limited to VERSOLLAN™ and VERSOLLAN™ TPE (Thermoplastic Polyurethane Elastomers), DYNAFLEX™, VERSAFLEX™ CL2003X, and VERSAFLEX™ CL 2000X (polyurea elastomers manufactured by VersaFlex, Inc., Kansas City, Kans.), all available from GLS Corporation (McHenry, Ill., USA), as well as KRATON™ styrenic block copolymer elastomers available from Kraton Polymers, LLC (Houston, Tex.). Also suitable for use as elastomers for use within the present invention are those elastomers that are soluble in high molecular weight (e.g., C₉-C₁₆) hydrocarbons, such as the ENGAGE™ polyolefin elastomers ENGAGE™ 8407, ENGAGE™ 8402, ENGAGE™ 8842, and ENGAGE™ 7467, all from DuPont Dow Elastomers, LLC (Wilmington, Del., USA). Specifically preferred for use herein are VERSAFLEX™ thermoplastic polyurea elastomers, such as VERSAFLEX™ CL2000X [which has a density of 0.87 g/cm³ and a tensile strength of 1724 kpa], and the polyolefin EGAGE™ elastomers such as ENGAGE™ 7467 [which has a density of 0.862 g/cm³ and a tensile strength of 2.6 MPa].

Elastomers suitable for use with the present invention have a melt index (as measured according to ASTM D-1238) from about 0.2 dg/min (degrees per minute, measured at 190° C. and 2.16 kg) to about 40.0 dg/min, and more preferably from about 1.0 dg/min to about 40.0 dg/min. Most preferably, elastomers suitable for use with the present invention have a melt index from about 1.0 dg/min to about 30.0 dg/min.

Elastomers suitable for use with the present invention also have a density range (as measured by ASTM D-792) from about 0.500 g/cm³ to about 1.000 g/cm³, and preferably have a density range from about 0.700 g/cm³ to about 1.000 g/cm³. Most preferably, the elastomers suitable for use within the present invention have a density from about 0.710 g/cm³ to about 0.990 g/cm³. For example, elastomers having a density of about 0.70 g/cm³, 0.71 g/cm³, 0.72 g/cm³, 0.73 g/cm³, 0.74 g/cm³, 0.75 g/cm³, 0.76 g/cm³, 0.77 g/cm³, 0.78 g/cm³, 0.79 g/cm³, 0.80 g/cm³, 0.81 g/cm³, 0.82 g/cm³, 0.83 g/cm³, 0.84 g/cm³, 0.85 g/cm³, 0.86 g/cm³, 0.87 g/cm³, 0.88 g/cm³, 0.89 g/cm³, 0.90 g/cm³, 0.92 g/cm³, 0.94 g/cm³, 0.96 g/cm³, 0.99 g/cm³, and densities between any two of these values (e.g., between 0.80 g/cm³ and 0.90 g/cm³) are suitable for use with the present invention.

Elastomers suitable for use within the present invention preferably have a glass transition temperature, T_{g}, such that the temperature at which there is an increase in the thermal expansion coefficient of the elastomer is less than about 600° F., preferably from about 100° F. to about 500° F., as well as in ranges of temperature within this range. For example, elastomers suitable for use with the present invention have a useable temperature range such that the lower end of the T_{g} is about 120° F. and the upper end of the T_{g} is about 250° F. (low temperature elastomers). Also suitable for use within the present invention, the elastomers can have a usable temperature range such that the lower end of the T_{g} is about 180° F. and the upper end of the T_{g} is about 500° F. (high temperature elastomers).

Additionally, the elastomers suitable for use within the present invention preferably have a tensile strength greater than about 10 Pa, and more preferably greater than about 1 kPa. As used herein, the term “tensile strength” refers to the maximum amount of tensile stress that can be applied to the elastomeric material before it ceases to be elastic, measured in units of force per unit area (N/m² or Pa) according to ASTM-standard D-638, ASTM D-412, or ISO 37 (available from the world wide web at astm.org).

A further distinguishing property of the elastomers suitable for use in the present invention is the “elongation at break” property. As used herein, “elongation at break” refers to the elongation recorded at the moment of rupture of the specimen, often expressed as a percentage of the original length; it corresponds to the breaking or maximum load, as measured by ASTM D-412 or ISO 37 (available from the world wide web at astm.org) and expressed as a percentage (%). Preferably, and in accordance with the present invention, elastomers used herein have an elongation at break of greater than 250%.

The viscosity of a fluid measured at the shear rate specified by API. In the Bingham plastic rheology model, apparent viscosity (AV) is one-half of the dial reading at 600 rpm (1022 sec⁻¹ shear rate) using a direct-indicating, rotational viscometer. For example, a 600-rpm dial reading is 50 and the AV is 50/2, or 25 cp. (E-70=75,000 mPa.s; Versaflex=2 Pa.sec (ASTM D-3835); Engage=20 (ASTM 1646; Mooney Viscosity).

The amount of the elastomer coated onto the proppant, either alone or in combination with other components and/or a resin coating (curable or uncurable) depends upon the specific application of the proppant, but is typically added in an amount from about 0.1 wt. % to about 20 wt. %, based on total weight of substrate. Preferably, the amount of elastomer added is from about 0.2 wt. % to about 10 wt. %, and more preferably the amount of elastomer added is from about 0.4 wt. % to about 8 wt. %. For example, and in accordance with the present invention, the elastomer (or elastomers) can be added in an amount of about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 2.0 wt. %, about 3.0 wt. %, about 4.0 wt. %, about 5.0 wt. %, about 6.0 wt. %, about 7.0 wt. %, about 8.0 wt. %, about 9.0 wt. %, and about 10.0 wt. %, as well as in any amount falling within the range defined by any two of these values, e.g., from about 0.5 wt. % to about 6.0 wt. %.

Fibers

The fibers suitable for use with the present invention include any of various kinds of commercially available fibers, including both soluble and insoluble fibers. Such fibers include but are not limited to members selected from the group consisting of polyethylene oxides, polypropylene oxides, polycaprolactones, milled glass fibers, milled ceramic fibers, milled carbon fibers, natural fibers, and synthetic fibers, e.g., crosslinked novolac fibers, having a softening point above typical starting temperature for blending with resin, e.g., at least about 200° F., so as to not degrade, soften or agglomerate.

The typical glasses suitable for use as insoluble fibers include E-glass, S-glass, and AR-glass, as well as carbon fibers, carbon/graphite fibers, ceramic fibers, and quartz fibers. E-glass is a commercially available grade of glass fibers typically employed in electrical uses. S-glass is used for its strength. AR-glass is used for its alkali resistance. The carbon and carbon/graphite fibers are of graphitized carbon. The ceramic fibers are typically alumina, porcelain, or other vitreous material. Quartz fibers are those fibers produced from high purity (>99.5%) SiO₂, such as fibrous quartz found in sedimentary rocks (chert), concretionary masses (flint), as replacement and alteration bodies in rocks, and in varied crevice and cavity fillings such as crustiform aggregates, geodes, and agates (chalcedony).

Fiber lengths range from about 6 microns to about 3200 microns (about ⅛ inch). Preferred fiber lengths range from about 10 microns to about 1600 microns. More preferred fiber lengths range from about 10 microns to about 800 microns. A typical fiber length range is about 0.001 to about 1/16 inch. Preferably, the fibers are shorter than the greatest length of the substrate. Suitable, commercially available fibers include but are not limited to milled glass fiber having lengths of 0.1 to about 1/32 inch; milled ceramic fibers 25 microns long; milled carbon fibers 250 to 350 microns long, and KEVLAR™ aramid (aromatic polyamide) fibers which are about 12 microns long (available from DuPont de Nemours & Co., Richmond, Va.). Fiber diameter (or, for fibers of non-circular cross-section, a hypothetical dimension equal to the diameter of a hypothetical circle having an area equal to the cross-sectional area of the fiber) range from about 1 to about 20 microns. Length to aspect ratio (length to diameter ratio) may range from about 5 to about 175. The fiber may have a round, oval, square, rectangular or other appropriate cross-section. One source of the fibers of rectangular cross-section may be chopped sheet material. Such chopped sheet material would have a length and a rectangular cross-section. The rectangular cross-section has a pair of shorter sides and a pair of relatively longer sides. The ratio of lengths of the shorter side to the longer side is typically about 1:2-10. The fibers may be straight, crimped, curled or combinations thereof.

The soluble fibers, or soluble fibrous materials, suitable for use with the present invention can be of any number of types of commercially available soluble fibers. Such fibers include but are not limited to: polyethylene oxides, polypropylene oxides, polycaprolactones; grafts of polyethylene/polypropylene and polycaprolenes; grafts of polyethylene/polypropylene oxides and polycaprolactones; water soluble or water reducible acrylics; water reducible phenoxy resin; latex; polyesters; soluble block copolymers; grafts of polyvinyl alcohol (PVA) and polyvinyl acetates; polyactides and derivatives of polyactic acid; polyglycolic acid (PGA); polyglycoliclactic acid (PGLA); collagen, especially fiberized collagen; proteins with very low molecular weights, such as tropocollagen (the molecular unit of collagen fibrils that consist of repeating three-stranded polypeptide units arranged head to tail in parallel bundles, is a right-handed triple helix composed of 2 polypeptide chains, and is rich in glycine, proline, hydroxyproline, and hydroxylysine); water-soluble polymer fibers; oil-soluble polymer fibers; acid-soluble polymer fibers; natural polymers, such as wheat-based polymers; organic fibers; natural fibers, such as wheat, rice, soy, and corn fibers; fibrous minerals, such as wollastinite; soluble ceramic fibers; salt-crystal fibers (e.g., those that would be isotonic in brine solution); calcium carbonate fibers; inorganic salts coated and bonded with water soluble fibers; and mixtures thereof. Preferably, the soluble fiber/fibrous material is a POLYOX™ water-soluble poly(ethylene oxide) polymer resin that is nonionic and has a molecular weight greater than about 100,000, such as POLYOX™ WSR N-80 (Dow Chemical, Freeport, Tex.).

Also envisioned to be suitable for incorporation with the present invention are mixtures of soluble fibers as listed above, as well as insoluble fibers. For example, the resin or polymer coating on the outer edge of the particulate substrate, or any of the other polymer or resin coating layers surrounding the particulate substrate, could contain a mixture of glass fibers and polyethylene oxide fibers in any suitable proportion. Such insoluble fibers suitable for use with the present invention include those selected from the group consisting of glass fibers, milled glass fibers, carbon fibers, milled carbon fibers, ceramic fibers such as alumina, porcelain, and other vitreous materials, and synthetic fibers that are substantially insoluble. By insoluble, it is meant that the fibers are inert to subterranean conditions (temperature, pressure, pH, etc.), and do not dissolve. It is believed that the use of a mixture of soluble and insoluble fibers or fibrous materials in one or more of the resin layers would produce a product having the benefits of increasing proppant drag while decreasing particulate backflow into the wellbore or above ground equipment, while simultaneously obtaining increased conductivity due to the conductivity microchannels formed by the soluble fibers upon dissolution.

Soluble fibers or soluble fibrous materials used in accordance with the present invention should be soluble (that is, capable of dissolving in) in brines, water, oil, organic solvents, acid or acidic media, and/or in fluids having a pH in the range from about I to about 14, as well as mixtures thereof.

B. Phenolic Resole and/or Novolac Resins

1. Resole Resins

The phenol-aldehyde resole resin has a phenol:aldehyde molar ratio from about 1:1 to about 1:3, typically from about 1:1 to about 1:1.95. A preferred mode of preparing the resole resin is to combine phenol with a source of aldehyde such as formaldehyde, acetaldehyde, propionaldehyde, furfural, benzaldehyde or paraformaldehyde under alkaline catalysis. During such reaction, the aldehyde is present in molar excess. It is preferred that the resole resin have a molar ratio of phenol to formaldehyde from about 1:1.1 to 1:1.6. The resoles may be conventional resoles or modified resoles. Modified resoles are disclosed by U.S. Pat. No. 5,218,038, incorporated herein by reference in its entirety. Such modified resoles are prepared by reacting aldehyde with a blend of unsubstituted phenol and at least one phenolic material selected from the group consisting of arylphenol, alkylphenol, alkoxyphenol, and aryloxyphenol.

Modified resole resins include alkoxy modified resole resins. Of alkoxy modified resole resins, methoxy modified resole resins are preferred. However, the phenolic resole resin which is most preferred is the modified orthobenzylic ether-containing resole resin prepared by the reaction of a phenol and an aldehyde in the presence of an aliphatic hydroxy compound containing two or more hydroxy groups per molecule. In one preferred modification of the process, the reaction is also carried out in the presence of a monohydric alcohol.

Phenols suitable for preparing the modified orthobenzylic ether-containing phenolic resole resins are generally any of the phenols which may be utilized in the formation of phenolic resins, and include substituted phenols as well as unsubstituted phenol per se. The nature of the substituent can vary widely, and exemplary substituted phenols include alkyl-substituted phenols, aryl-substituted phenols, cycloakyl-substituted phenols, alkenyl-substituted phenols, alkoxy-substituted phenols, aryloxy-substituted phenols and halogen-substituted phenols. Specific suitable exemplary phenols include in addition to phenol per se, o-cresol, m-cresol, p-cresol, 3,5-xylenol, 3,4-xylenol, 3,4,5-trimethyl phenol, 3-ethyl phenol, 3,5-diethyl phenol, p-butyl phenol, 3,5-dibutyl phenol, p-amyl phenol, p-cyclohexyl phenol, p-octyl phenol, 3,5-dicyclohexyl phenol, p-phenyl phenol, p-crotyl phenol, 3,5-dimethoxy phenol, 3,4,5-trimethoxy phenol, p-ethoxy phenol, p-butoxy phenol, 3-methyl-4-methoxy phenol, and p-phenoxy phenol. A preferred phenolic compound is phenol itself.

The aldehyde employed in the formation of the modified phenolic resole resins can also vary widely. Suitable aldehydes include any of the aldehydes previously employed in the formation of phenolic resins, such as formaldehyde, acetaldehyde, propionaldehyde and benzaldehyde. In general, the aldehydes employed contain from 1 to 8 carbon atoms. The most preferred aldehyde is an aqueous solution of formaldehyde.

Metal ion catalysts useful in production of the modified phenolic resins include salts of the divalent ions of Mn, Zn, Cd, Mg, Co, Ni, Fe, Pb, Ca and Ba. Tetra alkoxy titanium compounds of the formula Ti(OR₄ where R is an alkyl group containing from three to eight carbon atoms, are also useful catalysts for this reaction. A preferred catalyst is zinc acetate. These catalysts give phenolic resole resins wherein the preponderance of the bridges joining the phenolic nuclei are ortho-benzylic ether bridges of the general formula —CH₂(OCH₂)ₙ— where n is a small positive integer.

A molar excess of aldehyde per mole of phenol is used to make the modified resole resins. Preferably the molar ratio of phenol to aldehyde is in the range of from about 1:1.1 to about 1:2.2. The phenol and aldehyde are reacted in the presence of the divalent metal ion catalyst at pH below about 7. A convenient way to carry out the reaction is by heating the mixture under reflux conditions. Reflux, however, is not required.

To the reaction mixture is added an aliphatic hydroxy compound which contains two or more hydroxy groups per molecule. The hydroxy compound is added at a molar ratio of hydroxy compound to phenol of from about 0.001:1 to about 0.03:1. This hydroxy compound may be added to the phenol and aldehyde reaction mixture at any time when from 0% (i.e., at the start of the reaction) to when about 85% of the aldehyde has reacted. It is preferred to add the hydroxy compound to the reaction mixture when from about 50% to about 80% of the aldehyde has reacted.

Useful hydroxy compounds which contain two or more hydroxy groups per molecule are those having a hydroxyl number of from about 200 to about 1850. The hydroxyl number is determined by the standard acetic anhydride method and is expressed in terms of mg KOH/g of hydroxy compound. Suitable hydroxy compounds include ethylene glycol; propylene glycol, 1,3-propanediol, diethylene glycol, triethylene glycol, glycerol, sorb itol and polyether polyols having hydroxyl numbers greater than about 200. Glycerol is a particularly suitable hydroxy compound.

After the aliphatic hydroxy compound containing two or more hydroxy groups per molecule is added to the reaction mixture, heating is continued until from about 80% to about 98% of the aldehyde has reacted. Although the reaction can be carried out under reflux until about 98% of the aldehyde has reacted, prolonged heating is required and it is preferred to continue the heating only until about 80% to 90% of the aldehyde has reacted. At this point, the reaction mixture is heated under vacuum at a pressure of about 50 mm of Hg until the free formaldehyde in the mixture is less than about 1%. Preferably, the reaction is carried out at 95° C. until the free formaldehyde is less than about 0.1% by weight of the mixture. The catalyst may be precipitated from the reaction mixture before the vacuum heating step if desired. Citric acid may be used for this purpose. The modified phenolic resole may be “capped” to be an alkoxy modified phenolic resole resin. In capping, a hydroxy group is converted to an alkoxy group by conventional methods that would be apparent to one skilled in the art given the teachings of the present disclosure.

2. Phenol-aldehyde Novolac Polymer-containing Resins

An embodiment of the present invention employs resin which includes phenol-aldehyde novolac polymer. The novolac may be any novolac employed with proppants. The novolac may be obtained by the reaction of a phenolic compound and an aldehyde in a strongly acidic pH region. Suitable acid catalysts include the strong mineral acids such as sulfuric acid, phosphoric acid and hydrochloric acid as well as organic acid catalysts such as oxalic acid, or para toluenesulfonic acid. An alternative way to make novolacs is to react a phenol and an aldehyde in the presence of divalent inorganic salts such as zinc acetate, zinc borate, manganese salts, cobalt salts, etc. The selection of catalyst may be important for directing the production of novolacs which have various ratios of ortho or para substitution by aldehyde on the phenolic ring, e.g., zinc acetate favors ortho substitution. Novolacs enriched in ortho substitution, i.e., high-ortho novolacs, may be preferred because of greater reactivity in further cross-linking for polymer development. High ortho novolacs are discussed by Knop and Pilato, Phenolic Resins, p. 50-51 (1985) (Springer-Verlag) incorporated herein by reference. High-ortho novolacs are defined as novolacs wherein at least 60% of the total of the resin ortho substitution and para substitution is ortho substitution, preferably at least about 70% of this total substitution is ortho substitution.

The novolac polymer typically comprises phenol and aldehyde in a molar ratio from about 1:0.85 to about 1:0.4. Any suitable aldehyde may be used for this purpose. The aldehyde may be formalin, paraformaldehyde, formaldehyde, acetaldehyde, furfural, benzaldehyde or other aldehyde sources. Formaldehyde itself is preferred.

The novolacs used in this invention are generally solids such as in the form of a flake, powder, etc. The molecular weight of the novolac will vary from about 500 to 10,000, preferably 1,000 to 5,000 depending on their intended use. The molecular weight of the novolacs in this description of the present invention are on a weight average molecular weight basis. High-ortho novolac resins are especially preferred.

The resin composition typically comprises at least 10 weight percent novolac polymer, preferably at least about 20 weight percent novolac polymer, most preferably about 50 to about 70 weight percent novolac polymer. The remainder of the resin composition could include crosslinking agents, modifiers or other appropriate ingredients.

The phenolic moiety of the novolac polymer is selected from phenols of Formula I or bisphenols of Formula II, respectively: 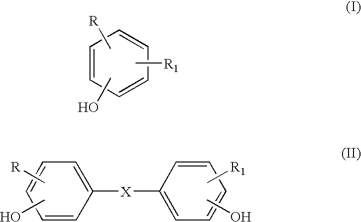
wherein R and R₁ are independently substituted or unsubstituted alkyl, substituted or unsubstituted aryl, substituted or unsubstituted arylalkyl, or H. In Formula II, R and R₁ are preferably meta to the respective hydroxy group on the respective aromatic ring. Unless otherwise defined, alkyl is defined as having 1 to 10 carbon atoms, and aryl is defined as having 5 to 6 carbon atoms in its ring. Further, aryl can also include substituted or unsubstituted heterocycles and heteroaryls, in which case one or more of the carbon atoms in the ring are substituted with a heteroatom, such as nitrogen (N), sulfur (S), oxygen (O), or any other suitable heteroatom known in the art. In Formula II, X is a direct bond, sulfonyl, alkylidene unsubstituted or substituted with halogen, cycloalkylidene, or halogenated cycloalkylidene. Alkylidene is a divalent organic radical of Formula III: 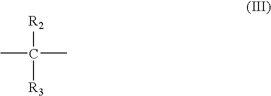
wherein X is alkylidene, and R₂ and R₃ are selected independently from H, alkyl, aryl, arylalkyl, heteroalkyl, heteroaryl, halogenated alkyl, halogenated aryl and halogenated arylalkyl. When X is halogenated alkylidene, one or more of the hydrogen atoms of the alkylidene moiety of Formula II are replaced by a halogen atom. Preferably the halogen is fluorine, bromine, or chlorine. Also, halogenated cycloalkylidene is preferably substituted by fluorine, bromine or chlorine on the cycloalkylidene moiety.

A typical phenol of Formula I is phenol, per se. Typical bisphenols of Formula II include Bisphenol A, Bisphenol C, Bisphenol E, Bisphenol F, Bisphenol S, or Bisphenol Z, all available from a variety of sources, such as Sigma-Aldrich (St. Louis, Mo.).

The present invention includes novolac polymers which contain any one of the phenols of Formula I, bisphenols of Formula II, or combinations of one or more of the phenols of Formula I and/or one or more of the bisphenols of Formula II. The novolac polymer may optionally be further modified by the addition of VINSOL™ thermoplastic resins (available from Darrin Chemical Co., Plantation, Fla.), epoxy resins, bisphenol, waxes, or other known resin additives. One mode of preparing an alkylphenol-modified phenol novolac polymer is to combine an alkylphenol and phenol at a molar ratio above 0.05:1. This combination is reacted with a source of formaldehyde under acidic catalysis, or divalent metal catalysis (e.g., Zn, Mn). During this reaction, the combination of alkylphenol and phenol is present in molar excess relative to the formaldehyde present. Under acidic conditions, the polymerization of the methylolated phenols is a faster reaction than the initial methylolation from the formaldehyde. Consequently, a polymer structure is built up consisting of phenolic and alkylphenolic nuclei, linked together by methylene bridges, and with essentially no free methylol groups. In the case of metal ion catalysis, the polymerization will lead to methylol and benzylic ethers, which subsequently break down to methylene bridges, and the final product is essentially free of methylol groups.

3. Crosslinking Agents and Other Additives for use With Phenolic Novolacs

For practical purposes, phenolic novolacs do not harden upon heating, but remain soluble and fusible unless a hardener (crosslinking agent) is present. Thus, in curing a novolac resin, a crosslinking agent is used to overcome the deficiency of alkylene-bridging groups to convert the resin to an insoluble infusible condition.

Appropriate crosslinking agents include hexamethylenetetramine (HEXA), paraformaldehyde, oxazolidines, melamine resin or other aldehyde donors and/or the above-described resole polymers. Each of these crosslinkers can be used by itself or in combinations with other crosslinkers. The resole polymer may contain substituted or unsubstituted phenol.

A resin composition of this invention typically comprises up to about 25 weight percent HEXA and/or up to about 90 weight percent resole polymers based on the total weight of coating composition. When HEXA is the sole crosslinking agent, the HEXA comprises from about 5 to about 25 weight percent of the resin. When the phenol-aldehyde resole polymer is the sole crosslinking agent, the resin contains from about 20 to about 90 weight percent of the resole polymer. The composition may also comprise combinations of these crosslinkers.

Additives are used for special cases for special requirements. The resin systems of the invention may include a wide variety of additive materials. The resin may also include one or more other additives such as a coupling agent such as a silane to promote adhesion of the coating to substrate, a silicone lubricant, a wetting agent, a surfactant, dyes, flow modifiers (such as flow control agents and flow enhancers), and/or anti-static agents. The surfactants may be anionic, nonionic, cationic, amphoteric or mixtures thereof. Certain surfactants also operate as flow control agents. Other additives include humidity resistant additives or hot strength additives. Of course, the additives may be added in combination or singly.

4. Methods to Make Resoles

A typical way to make resoles is to put a phenol in a reactor, add an alkaline catalyst, such as sodium hydroxide or calcium hydroxide, and aldehyde, such as a 50 weight % solution of formaldehyde, and react the ingredients under elevated temperature until the desired viscosity or free formaldehyde is achieved. Water content is adjusted by distillation. Elasticizers or plastizers, such as bisphenol A or cashew nut oil, may also be present to enhance the binder elasticity or plasticity. Other known additives known in the art may also be present.

5. Methods to Make Novolac Polymer

To make phenolic novolac polymers with one or more phenols of Formula 1, the phenol is mixed with acidic catalyst and heated. Then an aldehyde, such as a 50 weight % solution of formaldehyde is added to the hot phenol and catalyst at elevated temperature. Water made by the reaction is removed by distillation to result in molten novolac. The molten novolac is then cooled and flaked.

To make novolac polymers with bisphenols of Formula II, the bisphenol is mixed with a solvent, such as n-butyl acetate, at elevated temperature. An acid catalyst such as oxalic acid or methane sulfonic acid is then added and mixed with the bisphenol and then an aldehyde, typically formaldehyde, is added. The reactants are then refluxed. It is noted that the preparation of the novolac resin can occur under acidic catalysis, or divalent metal catalysis (e.g., Zn, Mn), wherein the bisphenol is present in greater than equimolar amount relative to the source of aldehyde. After reflux, water is collected by azeotropic distillation with n-butyl acetate. After removal of the water and n-butyl acetate, the resin is flaked to yield resin products. Alternatively, the polymers can be made using water as a solvent.

6. Reacting Aldehyde With Phenol-aldehyde Novolacs or Bisphenol-aldehyde Novolacs

Phenol-aldehyde novolacs or bisphenol-aldehyde novolacs may be modified by reacting these novolacs with an additional quantity of aldehyde using a basic catalyst. Typical catalysts used are sodium hydroxide, potassium hydroxide, barium hydroxide, calcium hydroxide (or lime), ammonium hydroxide and amines.

In the case of phenol-aldehyde polymers or bisphenol-aldehyde polymers, the molar ratio of added aldehyde to phenolic moiety, based on the phenolic moiety monomeric units in the novolac, ranges from 0.4:1 to 3:1, preferably from 0.8:1 to 2:1. This achieves a crosslinkable (reactive) polymer having different chemical structures and generally higher molecular weights than the resole polymers obtained by a single step process which involves initially mixing bisphenol monomers and aldehyde with an alkaline catalyst at the same molar ratio of the combined aldehyde and bisphenol. Furthermore, it is feasible to use different aldehydes at different stages of the polymer preparation.

These polymers can be used alone or with other polymers, such as phenol-aldehyde novolacs, bisphenol-aldehyde novolac, or combinations thereof, as a crosslinking agent, or as a component of crosslinking agents. When the aldehyde-modified polymers are employed as crosslinking agents, they may be used with other typical crosslinking agents such as those described above for novolac polymers.

7. Methods to Make Proppant With Resole or Novolac Heat Set Resins

After making the resole or novolac resins, the crosslinking agent, resin and filler particles are mixed at conditions to provide either a precured or curable resin composition, as desired. Whether a resin composition is of the precured or curable type depends upon a number of parameters. Such parameters include the ratio of the novolac resin to the curing agent; the acidity of the novolac resin; the pH of the resole resin; the amount of the crosslinking agent; the time of mixing the resin compositions and filler particles; the temperature of the resin compositions and filler particles during mixing; catalysts (if any) used during the mixing and other process parameters as known to those skilled in the art. Typically, the precured or curable proppants may contain resole resin in the presence or absence of novolac resin.

C. Methods of Making Elastomer-Containing Proppants

The elastomers-containing particles (or proppants) of the present invention can be made by any number of acceptable methods. The preferred methods generally comprise contacting the appropriate particulate material, such as sand or FCC ceramic, with one or more elastomers in the presence of an appropriate cross-linking agent, such as hexamethylenetetramine (HEXA) at an appropriate temperature and for a period of time sufficient to substantially coat the particles. For example, a simple elastomers-coated particle as shown in FIG. I includes a particle (10) substantially coated with an elastomer layer (12), and is prepared by contacting particle (10) with elastomer in the presence of a crosslinking agent for an appropriate period of time. As used herein, an appropriate period of time refers to the amount of time necessary to substantially completely carry out the specific operation, e.g., substantially coating the particle, and can generally be from a few seconds (e.g., I second) to several minutes (e.g., 5 minutes), as well as any suitable amount of time between these two values.

Variations on the general procedure for the manufacture of elastomer-coated proppant particles can also be performed so as to produce a variety of elastomer-coated particles, as described herein. For example, the particle (10) can be first coated with an appropriate resin, such as a phenolic resin, by contacting the particle with the resin at an appropriate temperature for a period of time sufficient to substantially coat the particle with a first resin coating layer (14), as shown in FIG. 2. The resin-coated particle can then be contacted with an elastomer and a cross-linking agent so as to provide a particle (10) having a first resin layer (14) and an outer elastomeric layer (16).

A further variation on the general procedure described herein comprises contacting the particle with an appropriate resin and a cross-linker at a temperature sufficient to generate a first, substantially resin layer coating, followed by contacting the resin-coated proppant particle with an elastomer containing about 1 wt. % to about 30 wt. % fibers (e.g., ceramic or glass fibers) at a temperature for a period of time sufficient to provide an outer coat that substantially comprises an elastomer and fibers mixed throughout the outer elastomer layer. This is shown in FIG. 3, wherein the particle (10) has a first resin coat (14) and an outer elastomer coat (16), wherein the elastomer coat (16) has numerous fibers (18) throughout the coating layer.

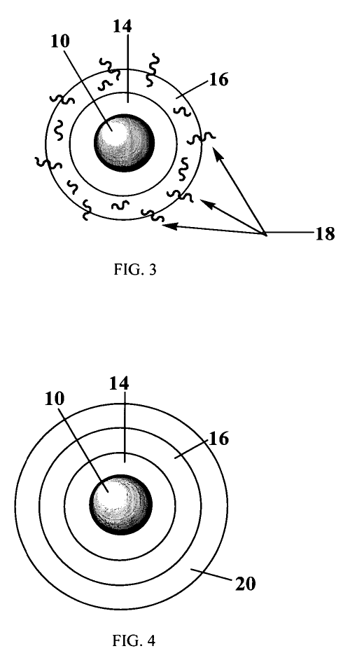

An alternative method of preparing elastomer-coated particle proppants of the present invention comprises contacting a particle with an appropriate resin and a cross-linker at a temperature sufficient to provide a first, substantially continuous resin layer coating. The resin coated proppant particle is then contacted with a cross-linking agents, such as HEXA, and an elastomer, so as to provide a second, substantially elastomeric coating on the particle. This second, elastomer layer can then have an outer coating, such as a soluble-resin coating, by contacting the resin and elastomer coated particle with a soluble resin for a period of time sufficient to substantially coat the particle. The resultant product is shown schematically in FIG. 4, wherein a particle (10) has a first, inner resin coat (14), an intermediate elastomer coat (16), and an outer coat (20) that is a soluble resin coating.

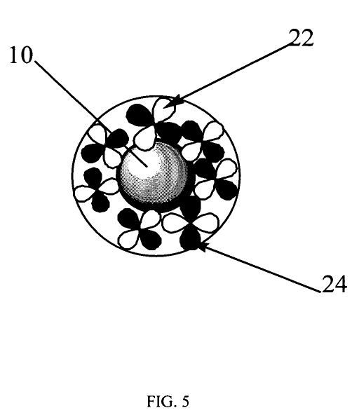

Yet another method of preparing elastomer-coated particle proppants of the present invention comprises contacting a particle with a mixture of a resin, such as a phenolic resin, and an elastomer for an appropriate amount of time to substantially coat the particle, at a desired temperature. Preferably, the resin and elastomer are separately blended together, and then the resin/elastomer mixture contacted with the particles at a temperature in the presence of a cross-linker for a period of time sufficient to substantially coat the particles. Such a product is illustrated in FIG. 5, wherein a particle (10) has a coating comprising both a resin (22) and an elastomer (24) mixed together. The resin-elastomer mixed coating can be substantially uniform in the amounts of resin and elastomer present (e.g., about 1:1), or there can be more elastomer than resin, or there can be more resin than elastomer. The ratio of elastomer to resin will depend upon the desired properties of the coated particle product.

The example processes and products given herein are by no means meant to limit the scope of the invention, and particles with multiple coatings, including multiple, alternating resin-elastomer-resin coatings are envisioned to be within the scope of the present invention.

The processes for preparing the elastomer coated particles of the present invention are preferably carried out at a temperature from about 50° F. and about 1,000° F., and more preferably at a temperature from about 100° F. and about 700° F. Most preferably, the processes of the present invention are carried out at a temperature from about 300° F. to about 650° F. Those of skill of art will know that adjustments to the temperature at which the process is carried out will depend to a degree upon the stability and melting temperature of the components (e.g., resins, elastomers) used in coating the particles.

The processes and compositions described herein offer a variety of benefits over conventionally used proppants, especially in addressing the issues of flowback control. For example, according to the process of the present invention, particulates are substantially encapsulated by at least one layering of elastomeric material, prior to being pumped downhole. Preferably, the elastomeric material forms the outer coating, or layer, on the particulate material, although it is envisioned that the particulate can have a coating of an appropriate soluble coating material immediately on top of the elastomeric coating, affording the elastomeric coating a degree of initial protection during the transport and downhole pumping of the particulates. For example, this may help to protect the elastomerically-coated proppant particle while it is pumped in a fracture fluid into a subterranean formation, whereupon arrival of the proppant at its desired placement, the soluble outer coating dissolves over time in the fracture fluid, exposing the elastomeric coating. The elastomerically coated particulates can then form a resilient and flexible coating between all the particulates in contact with each other, forming a flexible “proppant mass” that it is believed could help cushion and/or minimize the relative movement of the proppant pack, reduce or prevent crushing (and the subsequent generation of particulate “fines”), enhanced particle-to-particle adherence, minimize particle-to-particle contact to minimize crushing, and/or aid in encapsulating any fines or stray particulate matter during its constant melting and forming at downhole conditions. Any or all of these benefits and modes of action are believed to be efficiently and economically achieved using the elastomerically coated proppants of the present disclosure.

### HYPOTHETICAL PILOT FIELD EXAMPLE

The resin-coated, elastomer-containing particles produced by the above methods may be used as proppants in hydraulic fracturing, with the additional benefit of reducing proppant flowback. In carrying out a hydraulic fracturing operation, a fracture is first generated by injecting a viscous fluid into the formation at a sufficient rate and pressure to cause the formation to crack or fracture. A carrier fluid having the proppant of the present invention suspended therein is then pumped into the developing fracture until the desired fracture size has been achieved. The carrier fluid can return back out of the wellbore or bleed off into the formation, depositing the propping agent in the fracture.

For this example, a total of 1000 cubic feet of resin coated proppant having an elastomeric coating would be positioned in the fracture. In order to accomplish this, a total of 1000 cubic feet of sand or FCC having a commonly used particle size range of 20/40 mesh is obtained, washed and dried. The resin employed in the procedure is the phenolic resin Plenco 12727 obtained from Plastics Engineering Company, Sheboygan, Wis. This is a phenolic resin which applicants have found to be especially suitable for use in the process of the present invention. In order to properly coat all of the 1000 cubic feet of sand employed in this process, a total of approximately 75 gallons of this resin solution are required.

75 Gallons of the resin solution is formulated by mixing 60 gallons of the above described resin with 15 gallons of butyl acetate saturated with HEXA. The resin solution is prepared by first saturating the ester with HEXA and then mixing four parts of resin to this fluid mixture.

The proppant particles are then mixed with the resin solution in the ratio of one part by volume resin mix to 10 parts by volume sand. Mixing requires less than 5 minutes in order to ensure complete coating of the sand grains with the resin, after which the resin coated sand is mixed with the elastomer, Engage 7467, available from Dupont in Wellington, Del. The proppant with the resin and elastomers, having been prepared off-site (on on-site, if desired), are added to a tank containing essentially saturated salt water which also contains approximately 80 lbs of hydroxyethylcellulose per 1000 gallons of water and 0.01 percent by weight fluorescent dye to provide the needed viscosity for placement of the resin coated sand grains in the formation. This mixture, comprising the saturated salt carrier fluid and the suspended resin and elastomer-coated proppant are then pumped down the wellbore and into the fractures.

The above procedure is continued until the total desired amount of resin and elastomer-coated proppant has been formed, suspended in the brine carrier fluid and injected into the well where the particles establish the required grain to grain contact as the excess fracturing fluid leaks off into the formation. After the coated proppant has been injected, the well is shut-in for a period of time sufficient for the resin and elastomer material to polymerize, binding the proppant particles together while still maintaining sufficient permeability to permit passage of fluid therethrough.

As the pressure within the fracture approaches the normal formation pressure, the fracture walls close in on the proppant and apply an overburden stress thereto. The strength imparted by the coating helps maintain the integrity of the proppant. Initially, the resin crosslinks and fuses, forming a three dimensional permeable matrix which is porous to the oil or gas. As the temperature increases the polymerization reaction proceeds until the resin is cured into an insoluble and infusible cross-linked state. Additionally, due to the inclusion of the elastomeric coating, the elastomer-resin coated proppant is “rehealable”, in that while the cross-linked, fused proppant pack is insoluble, grain-to-grain contact in addition to downhole stresses within the pack can cause the pack to break and then re-form, due to the characteristics of the elastomeric coating.

This curable resin coating can be pre-applied to the proppant, applied on-the-fly during pumping of the treatment, or applied subsequently using a variety of carrier fluids or by dump bailing.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Preparation of Proppant with Elastomeric Coating

Thirty grams of washed Ottawa sand having a range of 20-40 mesh was heated in an electric forced air oven at a temperature of 520° F. The heated sand was placed in a stainless steel five gallon HOBAR™ mixer (Hobart Corp., Troy, Ohio) equipped with a stainless steel paddle mixing blade. ENGAGE™ 7467 elastomer (Dupont, Wellington, Del.), 0.6 grams, was added to the hot sand and mixed at medium speed for 30 seconds. After this time, a HEXA/water solution consisting of 6 grams of HEXA (hexamethylenetetramine) and 100 mL of water was added to the elastomer-sand mixture. The elastomer-sand-hexa-water mixture was mixed for an additional 15-20 seconds. The process was considered complete when the sand became free flowing in the mixer. The coated sand was discharged from the mixing bowl and allowed to cool before testing.

### Example 2

### Preparation of Proppant with Elastomeric and Resin Coating

Thirty pounds of washed Ottawa sand having a range of 20-40 mesh was heated in an electric forced air oven at a temperature of 550° F. The heated sand was placed in a stainless steel five gallon Hobart mixer equipped with a stainless steel paddle mixing blade. 0.6 Pounds of PLENCO™ 12727 phenolic resin (Plastics Engineering Co., Sheboygan, Wis.) was added to the hot sand and mixed at medium speed for 30 seconds. After this time, a hexa/water solution consisting of 0.2 pounds of HEXA (hexamethylenetetramine) and 100 mL of water was added to the resin-sand mixture. The resin-sand-hexa-water mixture was mixed for an additional 15-20 seconds. After this time, 0.3 pounds of ENGAGE™ 7467, an elastomer (Dupont, Wellington, Del.) was added to the resin-sand mixture in the mixer. An additional mix time of 200-230 seconds was allowed to let the elastomer bond on the outside of the resin coated sand. The process was considered complete when the sand became free flowing in the mixer. The coated sand was discharged from the mixing bowl and allowed to cool before testing.

### Example 3

### Preparation of Proppant with Mixture of Elastomer and Resin Coating

Thirty pounds of washed Ottawa sand having a range of 20-40 mesh was heated in an electric forced air oven at a temperature of 550° F. The heated sand was placed in a stainless steel five gallon HOBAR™ mixer equipped with a stainless steel paddle mixing blade. A mixture of phenolic resin and elastomer was formed separately by blending 15% VERSAFLEX™ CL-2000X elastomer (GLS Corporation, Arlington Heights, Ill.) with PLENCO™ 12727 phenolic resin (Plastics Engineering Co., Sheboygan, Wis.). 0.6 Pounds of the phenolic resin-elastomer mixture was added to the hot sand and mixed at medium speed for 30 seconds. After this time, a hexa/water solution consisting of 0.18 pounds of HEXA (hexamethylenetetramine) and 200 mL of water was added to the resin-sand mixture. The resin-elastomer-sand-hexa-water mixture was mixed for an additional 15-20 seconds. The process was considered complete when the sand became free flowing in the mixer. The coated sand was discharged from the mixing bowl and allowed to cool before testing.

### Example 4

### Preparation of Proppant with Elastomer and Fibers

Thirty pounds of washed Ottawa sand having a range of 20-40 mesh was heated in an electric forced air oven at a temperature of 430° F. The heated sand was placed in a stainless steel five gallon HOBART™ mixer equipped with a stainless steel paddle mixing blade. 0.6 Pounds of a mixture of VERSAFLEX™ CL-2003 elastomer (GLS Corporation) containing 10 wt. % ceramic fibers was then added to the hot sand and mixed at medium speed for 30 seconds. After this time, a hexa/water solution consisting of 0.2 pounds of HEXA (hexamethylenetetramine) and 200 mL of water was added to the resin-sand mixture. The resin-sand-hexa-water mixture was mixed for an additional 15-20 seconds. The process was considered complete when the sand became free flowing in the mixer. The coated sand was discharged from the mixing bowl and allowed to cool before testing.

### Example 5

### Preparation of Proppant with Elastomer, Resin, and Soluble-Resin Coating

Thirty pounds of washed Ottawa sand having a range of 20-40 mesh was heated in an electric forced air oven at a temperature of 550° F. The heated sand was placed in a stainless steel five gallon HOBART™ mixer equipped with a stainless steel paddle mixing blade. 0.6 Pounds of PLENCO™ 12727 phenolic resin was added to the hot sand and mixed at medium speed for 30 seconds. After this time, a hexa/water solution consisting of 0.2 pounds of HEXA (hexamethylenetetramine) and 100 mL of water was added to the resin-sand mixture. The resin-sand-hexa-water mixture was mixed for an additional 15-20 seconds. After this time, 0.15 pounds of VERSAFLEX™ CL-2000X, an elastomer (GLS Corporation, Arlington Heights, Ill.) was added to the resin-sand mixture in the mixer, followed by POLYOX™ WSR N-80, a water-soluble resin (Dow Chemical, Freeport, Tex.). An additional mix time of 200-230 seconds was allowed to let the elastomer bond on the outer layer of the resin coated sand, and to allow the water-soluble resin to bond to the out later of the elastomeric layer. The process was considered complete when the sand became free flowing in the mixer. The coated sand was discharged from the mixing bowl and allowed to cool before testing.

### Example 6

### Unconfined Compressive Strength Testing

A slurry was formed by mixing an 80.00 g sample of proppant from the above Example 2 with 100 ml of a 2% KCI/DI water solution. The slurry was mixed with a magnetic stirrer for 15 minutes. The slurry was then transferred to a Baroid filter press cell, and the excess liquid was allowed to leak off so that the proppant is evenly distributed. The cell was placed on a Dake hydraulic press (Dake, Grand Haven, Mich.) which had been preheated to 250° F. The press was ramped 100 psi per minute to a 500 psi closure. Once 500 psi closure had been achieved, the cell was subjected to 500 psi and 250° F. conditions for one hour.

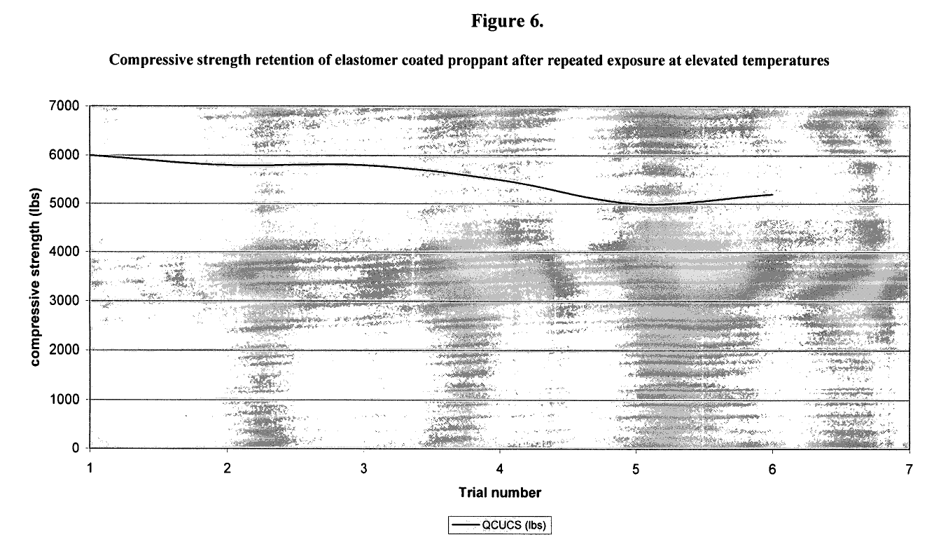

After one hour, the mass of consolidated proppant was carefully removed from the cell and allowed to cool. After cooling, the consolidated proppant sample was placed on an automated press and with smooth even strokes, the sample was subjected to an increasing closure stress, increasing at a rate of 100 psi/min. The compressive strength load (in pounds) was recorded at the point where catastrophic failure of the mass of consolidated proppants occurred. The load value was then divided by the surface area of the proppant pack, approx. 3.56 in², in order to calculate the unconfined compressive strength in pounds per square inch (psi). These values for the proppant of Example 2 are shown in FIG. 6.

It is important to mention that only one 80 gm sample was used in compressive strength testing of the elastomer coated proppant. The same sample was crushed and tested 6 times to determine the retention of compressive strength. The sample was exposed to 5% methanol and 2% Sodium Hydroxide solution for 30 minutes at 150° F. before it was tested the sixth time.

All of the compositions, methods and/or processes disclosed and claimed herein can be made and executed without undue experimentation in light of the present disclosure. While the compositions and methods of this invention have been described in terms of preferred embodiments, it will be apparent to those of skill in the art that variations may be applied to the compositions, methods and/or processes and in the steps or in the sequence of steps of the methods described herein without departing from the concept and scope of the invention. All such similar substitutes and modifications apparent to those skilled in the art are deemed to be within the scope and concept of the invention.

1. A proppant particle comprising:
a particulate substrate; and
a coating comprising a non-silicone containing elastomeric material,
wherein the elastomeric material has a density from about 0.500 g/cm³ to about 1.000 g/cm.

2. The proppant particle of claim 1, wherein the elastomeric material has a density from about 0.700 g/cm³ to about 0.990 g/cm³.

3. The proppant particle of claim 1, wherein the elastomeric material has a tensile strength of greater than about 10 Pa.

4. The proppant particle of claim 3, wherein the elastomeric material has a tensile strength greater than about 1 kPa.

5. The proppant particle of claim 1, wherein the elastomeric material is selected from the group consisting of polyolefin elastomers, copolymers of ethylene and trans 2-butene, syndiotactic polyethylenes, isotactic polyehtylenes, water-borne acrylics, latexes, and thermoplastic compounds.

6. The proppant particle of claim 1, wherein the elastomeric material is a thermoplastic compound selected from the group consisting of thermoplastic polyoctene compounds, thermoplastic elastomers compounded with thermoplastic polymers, thermoplastic polyurethane elastomers, and thermoplastic elastomers compounded with thermoset polymers.

7. The proppant particle of claim 6, wherein the elastomer is a thermoplastic polyurethane elastomer.

8. The proppant particle of claim 1, further comprising a curable or pre-cured resin-coating.

9. The proppant particle of claim 1, further comprising a soluble resin coating.

10. The proppant particle of claim 1, wherein the particulate substrate is selected from the group consisting of wherein the particulate substrate is selected from the group consisting of natural materials, silica proppants, ceramic proppants, metallic proppants, synthetic organic proppants, and mixtures thereof.

11. The proppant particle of claim 1, wherein the particulate substrate has a particle size in the range from about 4 mesh to about 200 mesh.

12. A proppant particle comprising:
a particulate substrate;
a resin coating; and
a coating comprising a non-silicone containing elastomeric material,
wherein the elastomeric material has a density from about 0.500 g/cm³ to about 1.000 g/cm³.

13. The proppant particle of claim 12, wherein the elastomeric material is a thermoplastic polyurethane elastomer.

14. The proppant particle of claim 12, wherein the resin coating is a curable or pre-cured resin coating.

15. The proppant particle of claim 12, wherein the resin coating is a phenolic resin.

16. The proppant particle of claim 12, wherein the resin coating contains fibrous material.

17. The proppant particle of claim 12, further comprising a soluble resin coating.

18. A method of treating a subterranean formation having a wellbore to prevent particulates from the subterranean formation from flowing back into the wellbore and/or surface equipment, the method comprising:
introducing into the subterranean formation the proppant particles of any one of claims 1-17.

19. A method of making a proppant particle, the method comprising the steps of:
providing a particulate substrate and an elastomeric material; and
combining the particulate substrate and the elastomeric material for a period of time sufficient to substantially coat the particulate substrate with the elastomeric material,
wherein the elastomeric material is selected from the group consisting of polyolefin elastomers, copolymers of ethylene and trans 2-butene, syndiotactic polyethylenes, isotactic polyehtylenes, water-bome acrylics, latexes, and thermoplastic compounds.

20. The method of claim 19, further comprising combining a resin with the particulate substrate and the elastomeric material, so as to provide a particulate substrate having a coating comprising a mixture of elastomeric material and resin.

21. A method of making a proppant particle, the method comprising:
providing a particulate substrate, a resin, and a non silicone containing elastomeric material having a density from about 0.500 g/cm³ to about 1.000 g/cm³;
combining the particulate substrate and the resin so as to form a coating mixture,
wherein the coating mixture substantially coats the particulate substrate with a coating of the resin so as to form a resin coated particulate substrate; and
combining the resin coated particulate substrate with the elastomeric material for a period of time sufficient to substantially coat the particulate substrate with the elastomeric material.

22. The method of claim 21, wherein the particulate substrate is heated to a temperature sufficient to melt the resin and form a mixture prior to the first combining step.

23. The method of claim 21, further comprising adding a cross-linking agent.

24. The method of claim 21, wherein the elastomeric material contains soluble fibers, insoluble fibers, or a mixture of soluble and insoluble fibers.

25. The method of claim 19, further comprising combining the elastomeric material coated particulate substrate with a soluble resin for a period of time sufficient to provide an outer layer on the particulate substrate that is substantially soluble resin.
